(19) United States
(12) Patent Application Publication
(10) Pub. No.: US 2026/0342590 A1
(43) Pub. Date: Oct. 29, 2026

(54) HARDWARE-ANCHORED POLICY-GOVERNED ARTIFICIAL INTELLIGENCE CODE GOVERNANCE SYSTEM

(71) Applicant: George William Bickerstaff, III, Greenwich, CT (US)

(72) Inventor: George William Bickerstaff, III, Greenwich, CT (US)

(21) Appl. No.: 19/714,454

(22) Filed: Jun. 20, 2026

(51) Int. Cl. H04L 9/32; H04L 9/00; H04L 9/30

(52) U.S. Cl. CPC H04L 9/3247; H04L 9/30; H04L 9/3218; H04L 9/50

(57) ABSTRACT

A hardware-anchored system generates software code by an artificial intelligence model executing within a trusted execution environment (TEE). A cryptographic attestation module binds, as a single signed structure, a hardware-rooted measurement of the TEE, a model identifier, and the inputs to the generated code. Validation agents independently evaluate the code; a consensus engine produces a decision; and a policy enforcement engine determines acceptance against machine-readable constraints. A tamper-resistant provenance ledger records the inputs, code, attestation evidence, validation outputs, decision, and acceptance, and may anchor digests to a public blockchain. A deployment orchestrator deploys conditional on acceptance. The code, attestation evidence, and decision exist unencrypted only within the TEE and are tamper-evidently bound to the measurement, so an operator cannot alter or suppress them without invalidating the attestation.

### CROSS-REFERENCE TO RELATED APPLICATIONS

This application claims the benefit of U.S. Provisional Patent Application No. 64/053,099, filed Apr. 29, 2026, under USPTO Customer Number 212041, the entire disclosure of which is incorporated herein by reference.

### FIELD OF THE INVENTION

The present disclosure relates to the generation, verification, governance, and deployment of software code produced by artificial intelligence models, and more particularly to architectures that bind artificial-intelligence-generated code to hardware-rooted trust anchors, cryptographic attestation evidence, multi-agent validation, tamper-resistant provenance, machine-enforced policy, and risk-aware deployment orchestration.

### BACKGROUND OF THE INVENTION

The present disclosure relates to systems, methods, and computer-readable media for the generation, verification, governance, and deployment of software code produced by artificial intelligence models. More particularly, the disclosure relates to architectures that bind artificial-intelligence-generated code to hardware-rooted trust anchors, cryptographic attestation evidence, multi-agent governance frameworks, tamper-resistant provenance ledgers, policy enforcement engines, and risk-aware deployment orchestration suitable for regulated, safety-critical, and enterprise environments.

Artificial intelligence (AI) systems, including large language models and other generative architectures, are increasingly used to produce executable software code from natural-language prompts, structured specifications, or programmatic inputs. Adoption of AI-generated code in regulated, safety-critical, financial, defense, healthcare, and other high-assurance settings introduces requirements that differ from those applicable in unregulated developer-productivity contexts.

Such regulated and high-assurance environments may impose, among other requirements: (i) integrity guarantees rooted in hardware that resist privileged-software tampering with model parameters, prompts, or generated outputs; (ii) cryptographic evidence binding generated code to a specific model identity, model version, prompt, configuration, and execution environment, sufficient to support reproducibility and third-party audit; (iii) machine-enforceable evaluation of generated code against regulatory, security, licensing, and organizational policy constraints prior to deployment; (iv) tamper-resistant audit trails capable of supporting regulatory examination, post-incident forensics, and independent verification; and (v) quantitative characterization of the security, operational, financial, and regulatory exposure associated with a generated code artifact, suitable for use in enterprise risk management, insurance underwriting, and capital-reserve calculations.

Among the regulatory and assurance frameworks under which one or more of the foregoing requirements may apply are the U.S. Health Insurance Portability and Accountability Act (HIPAA), the EU General Data Protection Regulation (GDPR), the Payment Card Industry Data Security Standard (PCI-DSS), U.S. Food and Drug Administration regulations governing software as a medical device (SaMD) including 21 C.F.R. Part 11, the Sarbanes-Oxley Act, FedRAMP, ISO/IEC 27001, IEC 62304, DO-178C, MIL-STD-882, MiFID II, Basel III/IV, the Dodd-Frank Wall Street Reform and Consumer Protection Act, and analogous frameworks in other jurisdictions.

The present disclosure addresses one or more of the foregoing requirements through architectures that integrate hardware-rooted trusted execution, cryptographic attestation, multi-agent validation, machine-enforced policy, tamper-resistant provenance, and risk-aware deployment orchestration as further described herein.

### SUMMARY OF THE INVENTION

Disclosed herein are systems, methods, and non-transitory computer-readable media for hardware-anchored, policy-governed generation, verification, and deployment of software code produced by artificial intelligence models. In one or more embodiments, AI-generated code is transformed into a verifiable, policy-compliant, and economically assessable artifact through the integration of trusted execution environments, cryptographic attestation, multi-agent validation and consensus, tamper-resistant provenance, machine-enforced policy, risk and economic scoring, and conditional autonomous deployment.

In one aspect, a system comprises one or more processors; a trusted execution environment (TEE) instantiated on at least one of the one or more processors; an artificial intelligence model executable within the TEE and configured to generate code in response to one or more inputs; a cryptographic attestation module configured to produce attestation evidence binding the generated code to a measurement of the TEE, an identifier of the artificial intelligence model, and the one or more inputs; a plurality of validation agents configured to independently evaluate the generated code; a consensus engine configured to produce a consensus decision based on outputs of the plurality of validation agents; a policy enforcement engine configured to determine acceptance of the generated code based on the consensus decision and one or more policy constraints; a provenance ledger configured to record, in a tamper-resistant manner, the inputs, the generated code, the attestation evidence, the outputs of the validation agents, and the consensus decision; and a deployment orchestrator configured to deploy the generated code conditional on acceptance by the policy enforcement engine. In one or more embodiments, the consensus engine computes the consensus decision as a weighted aggregation in which each validation output is assigned a configurable weight, one or more designated validation agents are assigned a veto weight that causes rejection upon a negative verdict, and acceptance requires a configured quorum threshold to be met.

In another aspect, a method comprises receiving, at a TEE, one or more inputs; generating, by an artificial intelligence model executing within the TEE, code based on the one or more inputs; producing cryptographic attestation evidence binding the generated code to a measurement of the TEE, an identifier of the model, and the inputs; evaluating the generated code by a plurality of validation agents; determining a consensus decision; determining acceptance based on the consensus decision and one or more policy constraints; recording the foregoing in a tamper-resistant provenance ledger; and conditionally deploying the generated code based on the acceptance.

In another aspect, a non-transitory computer-readable medium stores instructions that, when executed by one or more processors, cause the one or more processors to perform the disclosed operations.

Technical advantages of one or more disclosed embodiments include, without limitation: (i) hardware-rooted integrity for AI code generation; (ii) verifiable, third-party-auditable evidence of model identity, version, configuration, and execution environment; (iii) machine-enforced compliance with regulatory and organizational policy; (iv) tamper-resistant audit trails suitable for regulatory examination; (v) quantitative, deployment-relevant risk scoring; (vi) safe autonomous deployment in regulated environments; and (vii) interoperability with insurance underwriting, regulatory reporting, and enterprise risk management systems. Not every embodiment need provide all of the foregoing advantages, and additional advantages may be apparent from the disclosure. The disclosed architecture improves the functioning of a computer by providing a technical solution to a technical problem in computer security: it renders the governance of artificial-intelligence-generated code verifiable by binding generation, validation, and deployment to a hardware-rooted measurement within a trusted execution environment, such that the integrity of the governance decision is enforced by hardware rather than by trust in privileged software.

### BRIEF DESCRIPTION OF THE DRAWINGS

The disclosure is illustrated by way of example and not by way of limitation in the figures of the accompanying drawings. The drawings are organized as five figure groups, each comprising five subfigures, designated FIG. 1A through FIG. 5E. The drawings employ descriptive labels for components and do not rely upon reference numerals; like labels indicate like components throughout.

FIG. 1 depicts the overall code generation and governance system architecture, in subfigures FIG. 1A through FIG. 1E.

FIG. 2 depicts trusted execution environment instantiation, measurement, and attestation evidence, in subfigures FIG. 2A through FIG. 2E.

FIG. 3 depicts multi-agent validation, consensus voting, and override logic, in subfigures FIG. 3A through FIG. 3E.

FIG. 4 depicts the tamper-resistant provenance ledger and third-party verification, in subfigures FIG. 4A through FIG. 4E.

FIG. 5 depicts policy enforcement, risk scoring, deployment orchestration, and feedback, in subfigures FIG. 5A through FIG. 5E.

### DETAILED DESCRIPTION OF THE INVENTION

### Definitions

For purposes of the present disclosure and the appended claims, the following terms shall have the meanings set forth below. Definitions provided herein control over any inconsistent ordinary or technical usage. Each definition is open in form and inclusive.

“Input” means, without limitation, a natural-language prompt, a structured specification, a policy reference, a target-runtime identifier, a formal-specification annotation, audio data, video data, sensor telemetry, a compiled binary, and a multimodal embedding.

The following description sets forth specific details to provide a thorough understanding of various embodiments. One of ordinary skill in the art will appreciate that the disclosed embodiments may be practiced without one or more of the specific details and that numerous variations or modifications are possible without departing from the scope of the disclosure. Use of section headings is for convenience only and does not limit the disclosure.

As used herein, terms such as “module,” “engine,” “agent,” “orchestrator,” “framework,” and “subsystem” denote functional units that may be implemented, in various embodiments, as software instructions executed by one or more general-purpose processors, as firmware, as dedicated hardware (including without limitation application-specific integrated circuits, field-programmable gate arrays, hardware security modules, and specialized accelerators), as one or more services accessed over a network, or as any combination of the foregoing. Use of such terms is not intended to invoke 35 U.S.C. § 112(f), and each such functional unit is to be construed as a structural recitation in light of the corresponding embodiments described herein.

“Trusted execution environment” means a hardware-isolated execution context, instantiated on one or more processors, that protects the confidentiality and integrity of code, data, and state executing therein from observation or modification by privileged software outside the enclave, including a host operating system and a hypervisor, and that produces a hardware-rooted measurement of its software state usable for remote attestation; a TEE includes, without limitation, Intel SGX, Intel TDX, AMD SEV-SNP, ARM TrustZone, ARM CCA, AWS Nitro Enclaves, Azure Confidential Virtual Machines, Google Cloud Confidential Virtual Machines, a graphics processing unit or accelerator configured to operate in a confidential computing mode, and equivalent or successor confidential-computing primitives from any vendor.

“Hardware-rooted measurement” means a cryptographic digest, computed by hardware or by firmware verified by hardware, that uniquely identifies a software state loaded into a TEE, including without limitation initial code, configuration, and any sealed data, and that cannot be forged by software executing outside the TEE.

“Attestation evidence” means a signed data structure that binds an output of a TEE to a hardware-rooted measurement of the TEE, an identifier of code or a model executing within the TEE, one or more inputs to such code or model, and execution metadata, and that is verifiable by a relying party using a public key endorsed by a hardware root of trust. As used herein, a post-quantum or quantum-resistant cryptographic algorithm means an algorithm, including without limitation a lattice-based digital signature or key-encapsulation algorithm, believed resistant to cryptanalysis by quantum computation, of which ML-DSA and ML-KEM are non-limiting examples; recitation of a named algorithm is illustrative and not limiting.

“Hardware-bound key” means a cryptographic key whose use is restricted by hardware to a specific TEE state, the key being one or more of: sealed to a hardware-rooted measurement; derived from a hardware root of trust; or endorsed by a manufacturer-issued certificate.

(v) “Generated code,” as used herein, refers to executable software, source code, intermediate representation, configuration, infrastructure-as-code definition, machine-learning model artifact, or other structured output produced by an artificial intelligence model in response to one or more inputs.

(vi) “Validation agent,” as used herein, refers to a software entity that independently evaluates generated code with respect to a defined dimension and produces a validation output comprising at least a verdict, a confidence score, and supporting evidence. A validation agent may be implemented as a deterministic analyzer, a rule engine, an additional artificial intelligence model independent of the model that produced the generated code, or a combination thereof, and may itself execute within a TEE.

(vii) “Consensus decision,” as used herein, refers to an aggregated determination produced by a consensus engine from the validation outputs of two or more validation agents, the aggregation being performed in accordance with at least one of unanimous voting, majority voting, weighted voting, threshold voting, Byzantine-fault-tolerant consensus, or learned aggregation, and being subject to policy-defined override rules whereby specified validation outputs deterministically determine the consensus decision.

(viii) “Policy constraint,” as used herein, refers to a machine-readable rule, expressed in a policy language including without limitation Open Policy Agent (OPA) Rego, Cedar, AWS IAM policy syntax, eXtensible Access Control Markup Language (XACML), or a domain-specific language, the rule being evaluable against generated code, attestation evidence, validation outputs, a consensus decision, and associated metadata to produce an acceptance, rejection, modification, or escalation decision.

“Provenance ledger” means a cryptographically chained record, anchored periodically to a public blockchain by digest or Merkle root, configured such that alteration of a recorded entry is detectable, the specific events recorded being as recited by the claims of the application in which the term is used.

(x) “Risk score,” as used herein, refers to a quantitative or categorical value assigned to generated code that characterizes one or more of: a security risk; an operational impact; a financial exposure; or a regulatory liability associated with deployment of the generated code, the value being computed as a deterministic function of validation outputs, learned from historical incident data, produced by an additional artificial intelligence model, or any combination thereof.

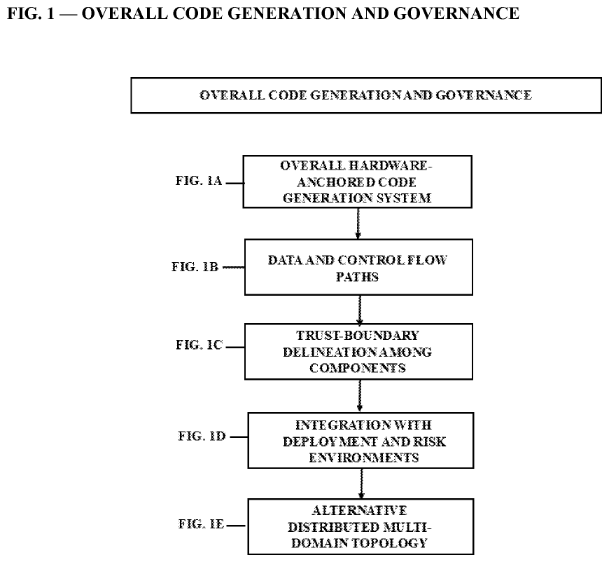

Referring to FIGS. 1A-1E, a system comprises an artificial intelligence model, a trusted execution environment (TEE), a cryptographic attestation module, a multi-agent validation framework comprising a plurality of validation agents and a consensus engine, a policy enforcement engine, a provenance ledger, a risk and economic scoring engine, and a deployment orchestrator. FIG. 1A illustrates the overall arrangement of these components. FIG. 1B illustrates data and control flow paths among the components. FIG. 1C illustrates trust-boundary delineation among hardware-isolated and non-isolated components. FIG. 1D illustrates integration with deployment, monitoring, and external risk-management environments. FIG. 1E illustrates an alternative distributed topology in which the components are deployed across multiple trust domains connected through cryptographically attested channels. Inputs may comprise, without limitation, natural-language prompts, structured specifications, source code fragments, configuration data, identifiers of target runtime environments, and references to one or more applicable policy sets. Outputs comprise the generated code, attestation evidence, validation reports, policy decisions, risk scores, and deployment artifacts.

Artificial intelligence model may comprise any model capable of producing code from inputs. In some embodiments, model comprises a transformer-based large language model. In other embodiments, model comprises a diffusion model, a state-space model, a retrieval-augmented generation (RAG) system, a tool-using agent, an agentic orchestration of one or more such models, or an ensemble of any of the foregoing. Model may be deterministic or stochastic; where stochastic, the random seed and sampling parameters are recorded in the attestation evidence to support reproducibility. Model may be hosted locally or accessed remotely through a confidential channel terminating within TEE, in which case the integrity and confidentiality of communications between model and TEE may be cryptographically protected.

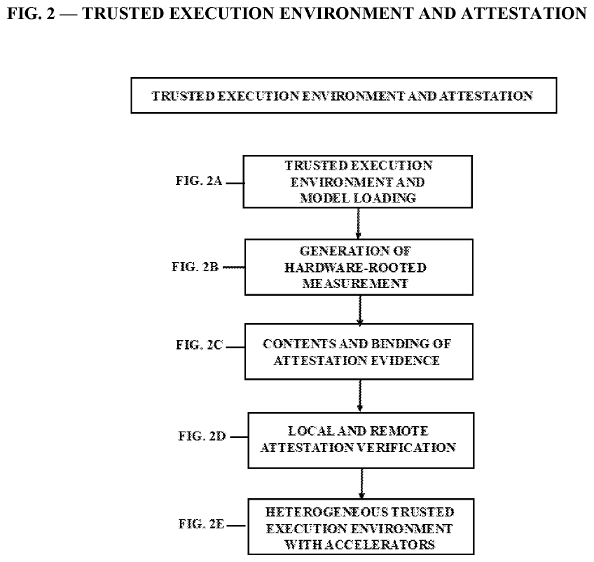

Referring to FIGS. 2A-2E, TEE provides hardware-isolated execution of model and produces a hardware-rooted measurement of its software state. FIG. 2A illustrates instantiation of TEE and loading of model thereinto. FIG. 2B illustrates generation of measurement. FIG. 2E illustrates a heterogeneous TEE comprising a host central processing unit and one or more attached accelerators, each operating in a confidential computing mode and bound through cryptographically attested channels. TEE may comprise any embodiment described in the Definitions section above. TEE protects inputs, model parameters, intermediate computations, and generated code from observation or modification by privileged software outside the TEE.

Referring to FIGS. 2C and 2D, cryptographic attestation module produces attestation evidence that binds generated code to a verifiable record of generation. FIG. 2C illustrates the contents of attestation evidence, comprising in various embodiments: (a) measurement of TEE; (b) an identifier and version of model; (c) a hash of inputs; (d) a hash of generated code; (e) execution metadata including timestamps, sampling parameters, and resource usage; and (f) a digital signature produced using a hardware-bound key associated with TEE. FIG. 2D illustrates verification of attestation evidence by a local verifier, a remote verification service, or a third party independent of an operator of system. Attestation evidence may be formatted in accordance with standards including, without limitation, the Internet Engineering Task Force (IETF) Remote Attestation Procedures (RATS) framework, Device Identifier Composition Engine (DICE) specifications, Trusted Platform Module (TPM) 2.0 quote formats, vendor-specific attestation formats, or proprietary equivalents.

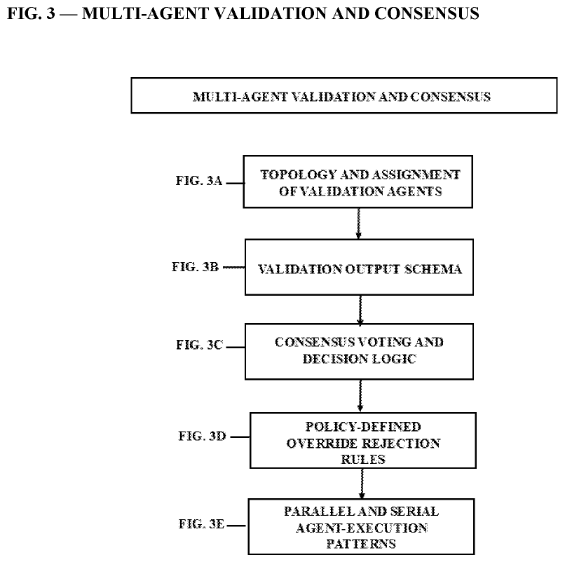

Referring to FIGS. 3A-3E, multi-agent validation framework comprises a plurality of validation agents. FIG. 3A illustrates topology and assignment of agents. FIG. 3B illustrates the validation output schema. FIG. 3E illustrates parallel and serial execution patterns. In various embodiments, validation agents include: a static analysis agent applying linting, taint analysis, and control-flow analysis; a security analysis agent applying signatures from the Common Weakness Enumeration (CWE), Common Vulnerabilities and Exposures (CVE), and equivalent registries; a fuzz-testing agent; a performance and cost analysis agent; a regulatory compliance agent applying machine-readable rules derived from one or more of HIPAA, GDPR, PCI-DSS, FDA 21 C.F.R. Part 11, the Sarbanes-Oxley Act, FedRAMP, and ISO/IEC 27001; an open-source license compliance agent applying SPDX-formatted policies; an intellectual-property-conflict agent comparing generated code against one or more corpora of protected works; and a reproducibility agent verifying determinism of generation. In some embodiments, at least one validation agent comprises a second artificial intelligence model independent of model in order to reduce common-mode failure.

Referring to FIGS. 3C and 3D, consensus engine produces a consensus decision based on the validation outputs. FIG. 3C illustrates voting and decision logic. FIG. 3D illustrates policy-defined override rules whereby specified validation outputs (for example, a critical security finding) deterministically reject the generated code regardless of other agents'verdicts.

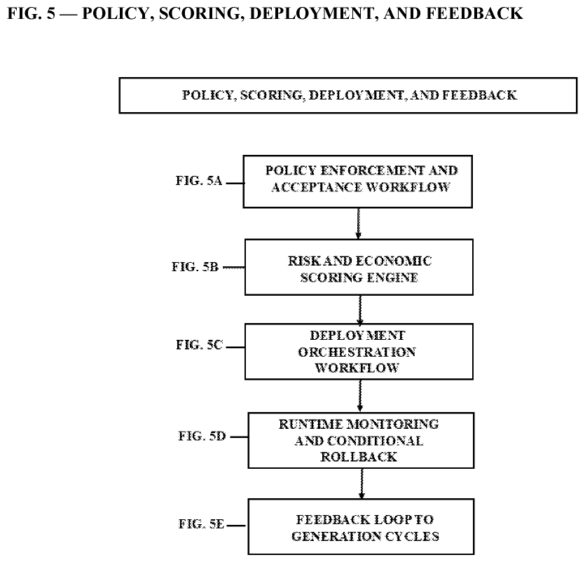

Referring to FIG. 5A, policy enforcement engine evaluates the generated code, the consensus decision, and any associated metadata against one or more policy constraints. Policy enforcement engine produces an acceptance, rejection, modification, or escalation decision. Policy constraints may include, without limitation, regulatory requirements, organizational security baselines, jurisdictional data-residency rules, license-compatibility rules, runtime resource limits, and risk thresholds. In some embodiments, policy enforcement engine supports versioned policy bundles signed by an authoritative policy authority, with the applicable policy version recorded in the attestation evidence and the provenance ledger.

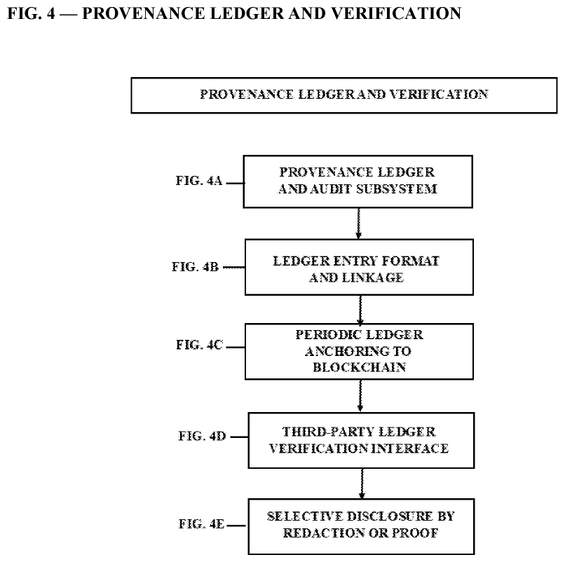

Referring to FIGS. 4A-4E, provenance ledger records, in tamper-resistant form, each event associated with the generation, validation, policy evaluation, and deployment of generated code. FIG. 4A illustrates the ledger architecture. FIG. 4B illustrates the entry format and cryptographic linkage. FIG. 4C illustrates periodic anchoring to a public blockchain such as Bitcoin or Ethereum. FIG. 4D illustrates a verification interface enabling third parties to independently confirm the integrity and ordering of recorded events. FIG. 4E illustrates selective disclosure of recorded entries through cryptographic redaction, zero-knowledge proofs, or equivalent techniques.

Referring to FIG. 5B, risk and economic scoring engine assigns one or more scores to each generated code artifact. Scores comprise a security risk score derived from CWE/CVE matches and exploitability metrics; an operational impact score reflecting blast radius, dependency depth, and criticality of affected systems; a financial exposure score estimating expected loss in the event of failure or exploitation; and a regulatory liability score reflecting potential exposure under one or more applicable regulatory regimes. Scores may be transmitted to external systems including, without limitation, insurance underwriting platforms to adjust premiums; capital-reserve calculation engines to adjust regulatory capital; enterprise risk management systems; regulatory reporting systems; and executive dashboards.

Referring to FIGS. 5C and 5D, deployment orchestrator conditionally deploys the generated code based on the policy decision and, in some embodiments, on the risk score. FIG. 5C illustrates a deployment workflow. FIG. 5D illustrates runtime monitoring and conditional rollback. Deployment orchestrator may integrate with continuous integration and continuous deployment (CI/CD) pipelines, GitOps controllers, container registries, package repositories, and runtime environments. Deployed artifacts are signed using a hardware-bound key derived from or endorsed by TEE and may include a software bill of materials (SBOM) and references to corresponding entries in provenance ledger. In some embodiments, deployment orchestrator produces or consumes attestation artifacts conformant with one or more of the Supply chain Levels for Software Artifacts (SLSA), in-toto, and Sigstore frameworks.

Referring to FIG. 5E, in some embodiments, signals derived from validation agents, consensus engine, policy enforcement engine, risk scoring engine, and runtime monitoring of deployed code are fed back to model to improve subsequent generations. Feedback may be applied through fine-tuning, reinforcement learning from validator feedback, retrieval-index updates, prompt-level guardrails, or any combination of the foregoing. Feedback signals are themselves recorded in provenance ledger to preserve auditability of model evolution.

In an exemplary workflow: (a) inputs are received at TEE; (b) model, executing within TEE, generates code; (c) attestation module produces attestation evidence; (d) the generated code, inputs, and attestation evidence are submitted to validation framework; (e) consensus engine produces a consensus decision; (f) policy enforcement engine produces a policy decision; (g) risk scoring engine produces one or more risk scores; (h) all artifacts are recorded in provenance ledger; and (i) deployment orchestrator conditionally deploys the generated code. Each step may be performed sequentially or, where dependencies permit, in parallel.

In a healthcare embodiment, system generates clinical decision support, software-as-a-medical-device (SaMD), electronic health record (EHR) integration code, or related clinical software. Validation agents include a HIPAA-compliance agent, an FDA 21 C.F.R. Part 11 agent (electronic records and signatures), an IEC 62304 software lifecycle agent, and a clinical-safety agent. Provenance ledger produces audit trails sufficient to support premarket submissions and post-market surveillance under applicable FDA frameworks. Risk scoring engine estimates patient-safety exposure and reports to a quality management system.

In a financial services embodiment, system generates trading-system components, risk-engine modules, regulatory-reporting code, or smart contracts. Validation agents include compliance agents directed to one or more of the Sarbanes-Oxley Act, MiFID II, Basel III/IV, and the Dodd-Frank Wall Street Reform and Consumer Protection Act. Risk scoring engine quantifies financial exposure and integrates with capital-reserve and economic-capital systems. Deployment orchestrator enforces change-management controls and produces evidence supporting regulatory examination.

In a defense and aerospace embodiment, system produces high-assurance code subject to standards such as DO-178C and MIL-STD-882. Multi-agent consensus may be configured to require unanimous approval. A hardware-verified chain-of-trust extends from TEE through deployment to fielded systems. Provenance ledger supports classified-handling controls.

In an enterprise software-as-a-service embodiment, system governs AI coding tools used across an organization. Policy enforcement engine enforces organization-wide rules. Provenance ledger supports internal audit, vendor risk management, and SOC 2 attestations. Deployment orchestrator integrates with existing CI/CD pipelines.

In an insurance embodiment, risk scores produced by engine are transmitted to underwriting models that adjust premiums for cyber, errors-and-omissions, technology liability, or product liability coverages. Provenance ledger provides claims-defense evidence in the event of disputed loss.

### Enablement Example 1—Clinical Decision Support Code Under HIPAA and FDA 21 C.F.R. Part 11

The following non-limiting example illustrates an end-to-end embodiment of system in a healthcare context. A hospital information-technology team operates system on a server having an Intel Xeon processor with Intel Trust Domain Extensions (TDX) and an attached NVIDIA H100 graphics processing unit configured in confidential computing mode. TEE is instantiated as a TDX trust domain bound to the H100 through cryptographically attested PCIe channels in accordance with FIG. 2E. Artificial intelligence model, comprising a 70-billion-parameter transformer trained on permissively licensed code corpora, is loaded into TEE, and measurement is recorded by the TDX module.

Inputs comprise: (a) a natural-language prompt requesting a Python module that computes a sepsis early-warning score from a stream of HL7 FHIR Observation resources; (b) a structured specification of input fields, output thresholds, and audit logging requirements; (c) a signed policy bundle, in OPA Rego format, encoding rules derived from HIPAA (including the minimum-necessary standard), FDA 21 C.F.R. Part 11 (audit-trail and electronic-signature requirements), and IEC 62304 Class B software lifecycle requirements; and (d) a target deployment manifest identifying a Kubernetes namespace, container registry, and SBOM repository. Model, executing within TEE, produces a Python module of approximately 480 lines, an associated unit-test suite, and a structured rationale.

Cryptographic attestation module produces attestation evidence in IETF RATS format comprising measurement, a SHA-256 hash of model weights, the prompt and specification hashes, the random seed and sampling temperature used during generation, and a digital signature produced using a hardware-bound key sealed to measurement. The generated code, inputs, and attestation evidence are submitted to validation framework. Validation agents comprise: (a) a static analysis agent (Bandit and Semgrep rules) reporting no high-severity findings; (b) a security analysis agent reporting no CWE-Top-25 matches; (c) a HIPAA-compliance agent confirming that all PHI fields are accessed only through audited interfaces and that minimum-necessary annotations are present; (d) a 21 C.F.R. Part 11 agent confirming that audit-log emission and electronic-signature hooks are present; (e) an IEC 62304 agent confirming that software-safety-class annotations and traceability identifiers are present; (f) a clinical-safety agent (an additional artificial intelligence model independent of model) flagging two boundary cases for human review; and (g) a reproducibility agent confirming determinism under the recorded seed.

Consensus engine applies weighted voting in which the HIPAA, Part 11, and clinical-safety agents are assigned veto weight, and produces a consensus decision of “accept with required human review.” Policy enforcement engine evaluates the consensus decision and the boundary-case findings against the signed policy bundle and produces an “escalation” decision routing the artifact to a designated clinical reviewer. Risk and economic scoring engine produces a security risk score of 0.12 (low), an operational impact score of 0.45 (moderate, reflecting potential effect on triage decisions), a patient-safety score of 0.30 (moderate-low), and a regulatory liability score of 0.20 (low). Provenance ledger, implemented as a Hyperledger Fabric channel anchored hourly to Ethereum, records inputs, the generated code, attestation evidence, all validation outputs, the consensus decision, the policy decision, the risk scores, the human-reviewer identity and signature upon completion, and the resulting deployment metadata. Following human review and approval, deployment orchestrator deploys a signed container image, accompanied by an SPDX-format SBOM, to the designated Kubernetes namespace, with continuous monitoring configured to roll back the deployment if runtime metrics deviate from the policy-defined envelope.

### Enablement Example 2—Smart-Contract Generation Under Basel III/IV and Sarbanes-Oxley

The following non-limiting example illustrates an end-to-end embodiment of system in a financial-services context. An investment bank operates system on AMD EPYC processors with Secure Encrypted Virtualization with Secure Nested Paging (SEV-SNP), with TEE instantiated as an SEV-SNP confidential virtual machine. Artificial intelligence model comprises a transformer-based code-generation model fine-tuned on Solidity and on the bank's internal Solidity style guide, loaded into TEE with measurement recorded by the AMD Platform Security Processor.

Inputs comprise: (a) a structured specification of a smart contract for atomic delivery-versus-payment settlement of tokenized corporate bonds, including counterparty roles, settlement windows, and escrow conditions; (b) a signed policy bundle, in OPA Rego format, encoding rules derived from the Sarbanes-Oxley Act (change-management and segregation-of-duties controls), MiFID II (transaction-reporting fields), Basel III/IV (capital-treatment annotations for trading-book exposures), and the bank's internal smart-contract security baseline; and (c) a target deployment manifest identifying a private Ethereum-compatible chain, a contract registry, and a regulatory-reporting endpoint. Model produces a Solidity contract of approximately 320 lines, an associated Foundry test suite, and a structured rationale.

Cryptographic attestation module produces attestation evidence binding the generated contract to measurement, model identifier and version, hashes of the specification and policy bundle, sampling parameters, and a digital signature produced using a hardware-bound key. Validation agents comprise: (a) a static analysis agent (Slither) reporting no high-severity findings; (b) a security analysis agent applying the Smart Contract Weakness Classification (SWC) registry, reporting no SWC-Top-10 matches; (c) a formal-verification agent invoking the Certora Prover against safety properties derived from the specification, returning proofs for 14 of 15 invariants and a counterexample trace for the fifteenth invariant; (d) a Sarbanes-Oxley change-management agent confirming that all state-mutating functions emit auditable events and require multi-signature authorization; (e) a MiFID II agent confirming the presence of all required transaction-reporting fields; (f) a Basel III/IV agent attaching a capital-treatment annotation; (g) a fuzz-testing agent reporting 12 hours of fuzzing without invariant violation; and (h) a reproducibility agent confirming determinism.

Consensus engine applies Byzantine-fault-tolerant consensus among the agents, with the formal-verification agent assigned veto weight on safety-property failures. Because the formal-verification agent has reported a counterexample, consensus engine produces a consensus decision of “reject with remediation request,” and the counterexample trace is fed back to model in accordance with FIG. 5E. Model produces a revised contract; the foregoing pipeline re-executes; all 15 invariants are now proved; and consensus engine produces a consensus decision of “accept.” Policy enforcement engine evaluates the consensus decision against the signed policy bundle and produces an “accept with conditional deployment” decision requiring deployment first to a staging environment. Risk and economic scoring engine produces a security risk score of 0.08 (low), an operational impact score of 0.55 (moderate-high, reflecting potential settlement-volume exposure), a financial exposure score of 0.40 (moderate), and a regulatory liability score of 0.25 (low-moderate); the financial exposure score is transmitted to the bank's capital-reserve calculation engine, and the regulatory liability score is transmitted to the bank's enterprise risk management system. Provenance ledger records all artifacts, including both the rejected and the accepted contract versions and the feedback signals exchanged with model. Deployment orchestrator deploys the signed contract to staging with continuous monitoring; promotion to production requires an independent human approval recorded in provenance ledger.

In a first concrete embodiment, the trusted execution environment comprises an Intel TDX trust domain; the artificial intelligence model generates infrastructure-as-code in response to a natural-language prompt; the attestation module produces ML-DSA-signed attestation evidence binding the generated code to a TDX measurement, a model identifier, and the prompt; five validation agents independently evaluate the code; a consensus engine requires a four-of-five quorum; and the deployment orchestrator deploys only upon acceptance, with ledger entries anchored to a public blockchain every sixty seconds. In a second concrete embodiment, the trusted execution environment comprises an AWS Nitro Enclave with an attached accelerator operating in a confidential computing mode; a policy enforcement engine conditions acceptance upon receipt of an attested formal verification proof of a memory-safety property from a separate formal-verification subsystem; a risk scoring engine assigns a risk score and transmits it to an enterprise risk-management system that adjusts a capital reserve; and runtime monitoring triggers a rollback to a prior attested state within five hundred milliseconds upon detected policy deviation. In a third concrete embodiment, the trusted execution environment comprises an AMD SEV-SNP confidential virtual machine; the attestation module produces an ML-KEM-encapsulated, ML-DSA-signed attestation evidence binding the generated configuration to a SEV-SNP measurement, the model identifier, and a structured specification; seven validation agents evaluate the configuration with a policy-defined override rule that deterministically rejects upon a failed security verdict; and the provenance ledger anchors entries to a public blockchain every thirty seconds.

### ALTERNATIVE EMBODIMENTS

The foregoing embodiments are illustrative and not limiting. In alternative embodiments, the trusted execution environment comprises any confidential-computing primitive, including successor technologies, and the artificial intelligence model comprises any generative architecture producing code, configuration, or infrastructure-as-code. Broader and related subject matter, including federated multi-domain topologies, formal-verification proof generation, runtime continuous re-attestation, post-quantum key lifecycle management, and economically governed multi-agent orchestration, is reserved for one or more continuation, continuation-in-part, or divisional applications and is not claimed herein. The system recites, where applicable, attested outputs of companion subsystems as received input without re-performing the functions of those subsystems. The present disclosure consumes outputs of companion subsystems as attested inputs and does not require re-performing the companion subsystem's claimed functions.

What is claimed is:

1. A system for hardware-anchored generation and governance of software code produced by an artificial intelligence model, the system comprising: one or more processors and a trusted execution environment (TEE) instantiated thereon; an artificial intelligence model executable within the TEE and configured to generate code in response to one or more inputs; a cryptographic attestation module configured to produce attestation evidence that cryptographically binds, as a single signed structure, (i) a hardware-rooted measurement of the TEE, (ii) an identifier of the artificial intelligence model, and (iii) the one or more inputs, to the generated code; a plurality of validation agents configured to independently evaluate the generated code and to produce respective validation outputs; a consensus engine configured to produce a consensus decision by combining the validation outputs according to a configured voting protocol; a policy enforcement engine configured to determine acceptance of the generated code based on the consensus decision and one or more machine-readable policy constraints; a provenance ledger configured to record, in a tamper-resistant manner, the one or more inputs, the generated code, the attestation evidence, the validation outputs, the consensus decision, and the acceptance; and a deployment orchestrator configured to deploy the generated code conditional on the acceptance; wherein the generated code, the attestation evidence, and the consensus decision are computed over data that exists in unencrypted form only within the TEE, and are tamper-evidently bound to the hardware-rooted measurement such that the generated code, the attestation evidence, the consensus decision, or the acceptance cannot be altered, suppressed, or substituted by privileged software outside the TEE without invalidating the attestation evidence.

2. The system of claim 1, further comprising a claims-defense evidence module configured to assemble, from the provenance ledger, a tamper-evident evidence record binding the attestation evidence, the consensus decision, and the acceptance, for regulatory reporting to a relying party.

3. The system of claim 1, wherein the attestation evidence binds the generated code to the hardware-rooted measurement, the identifier of the artificial intelligence model, and the one or more inputs collectively, such that verification of the attestation evidence fails if any one of the generated code, the model identifier, or the inputs is altered.

4. The system of claim 1, wherein the one or more inputs comprise at least one of a natural-language prompt, a structured specification, a configuration, and a programmatic input.

5. The system of claim 1, further comprising a verification interface configured to enable a relying party independent of an operator of the system to confirm, using a public key endorsed by a hardware root of trust, that the deployed code corresponds to the attestation evidence recorded in the provenance ledger.

6. The system of claim 1, wherein the consensus engine is configured to apply one or more policy-defined override rules whereby a specified validation output deterministically rejects the generated code regardless of other validation outputs.

7. The system of claim 1, wherein the provenance ledger is configured to record, and the deployment orchestrator is configured to consume, an artifact comprising at least one of a software bill of materials, an SPDX document, an in-toto attestation, a Supply-chain Levels for Software Artifacts attestation, and a Sigstore transparency-log entry, and wherein the one or more machine-readable policy constraints are expressed in at least one of Open Policy Agent Rego and Cedar.

8. The system of claim 1, wherein the provenance ledger is configured to cryptographically link each entry to a prior entry and to periodically anchor a digest of entries to a public blockchain.

9. The system of claim 1, further comprising a risk scoring engine configured to assign a risk score to the generated code and to transmit the risk score to at least one of an insurance underwriting system, a capital-reserve calculation system, and an enterprise risk-management system that consumes the risk score to govern deployment.

10. The system of claim 1, wherein the TEE comprises a heterogeneous trusted execution environment including a host central processing unit and one or more attached accelerators each operating in a confidential computing mode and bound through cryptographically attested channels.

11. The system of claim 1, wherein the policy enforcement engine is further configured to receive, as attested input from a separate formal-verification subsystem, one or more formal verification proofs of a property of the generated code, and to condition acceptance further upon the received proofs, without the system re-deriving the proofs.

12. The system of claim 1, wherein the deployment orchestrator is configured to perform a conditional rollback to a prior attested state in response to runtime monitoring indicating deviation from the one or more policy constraints.

13. The system of claim 1, wherein the attestation evidence comprises a single signed governance object that cryptographically binds, in one signed structure, the hardware-rooted measurement, the identifier of the artificial intelligence model, one or more hashes of the one or more inputs, a hash of the generated code, the validation outputs, the consensus decision, a policy-version identifier of the one or more machine-readable policy constraints, a risk score assigned to the generated code, and the acceptance, such that verification of the governance object fails if any bound element is altered.

14. A computer-implemented method for hardware-anchored generation and governance of software code produced by an artificial intelligence model, the method comprising: generating, by an artificial intelligence model executing within a trusted execution environment (TEE) instantiated on one or more processors, code in response to one or more inputs; producing attestation evidence that cryptographically binds, as a single signed structure, a hardware-rooted measurement of the TEE, an identifier of the artificial intelligence model, and the one or more inputs, to the generated code; evaluating the generated code by a plurality of validation agents to produce respective validation outputs; producing a consensus decision by combining the validation outputs according to a configured voting protocol; determining acceptance of the generated code based on the consensus decision and one or more machine-readable policy constraints; recording, in a tamper-resistant provenance ledger, the one or more inputs, the generated code, the attestation evidence, the validation outputs, the consensus decision, and the acceptance; and deploying the generated code conditional on the acceptance; wherein the generated code, the attestation evidence, and the consensus decision are computed over data existing in unencrypted form only within the TEE and are tamper-evidently bound to the hardware-rooted measurement such that none of the generated code, the attestation evidence, the consensus decision, or the acceptance can be altered, suppressed, or substituted by privileged software outside the TEE without invalidating the attestation evidence.

15. The method of claim 14, further comprising enabling a relying party independent of an operator to confirm, using a public key endorsed by a hardware root of trust, that the deployed code corresponds to the attestation evidence recorded in the provenance ledger.

16. The method of claim 14, further comprising receiving, as attested input from a separate formal-verification subsystem, one or more formal verification proofs of a property of the generated code, and conditioning the acceptance further upon the received proofs without re-deriving the proofs.

17. The method of claim 14, further comprising assigning a risk score to the generated code and transmitting the risk score to at least one of an insurance underwriting system, a capital-reserve calculation system, and an enterprise risk-management system that consumes the risk score to govern deployment.

18. The method of claim 14, further comprising periodically anchoring a digest of entries of the provenance ledger to a public blockchain.

19. A non-transitory computer-readable medium storing instructions that, when executed by one or more processors, cause the one or more processors to: generate, by an artificial intelligence model executing within a trusted execution environment (TEE), code in response to one or more inputs; produce attestation evidence that cryptographically binds, as a single signed structure, a hardware-rooted measurement of the TEE, an identifier of the artificial intelligence model, and the one or more inputs, to the generated code; evaluate the generated code by a plurality of validation agents to produce respective validation outputs; produce a consensus decision from the validation outputs; determine acceptance of the generated code based on the consensus decision and one or more machine-readable policy constraints; record, in a tamper-resistant provenance ledger, the inputs, the generated code, the attestation evidence, the validation outputs, the consensus decision, and the acceptance; and deploy the generated code conditional on the acceptance; wherein the generated code, the attestation evidence, and the consensus decision are computed over data existing in unencrypted form only within the TEE and are tamper-evidently bound to the hardware-rooted measurement such that none thereof can be altered, suppressed, or substituted by privileged software outside the TEE without invalidating the attestation evidence.

20. The non-transitory computer-readable medium of claim 19, wherein the instructions further cause the one or more processors to enable a relying party independent of an operator to confirm, using a public key endorsed by a hardware root of trust, that the deployed code corresponds to the attestation evidence recorded in the provenance ledger.
